(19) United States
(12) Patent Application Publication
(10) Pub. No.: US 2021/0217105 A1
(43) Pub. Date: Jul. 15, 2021

(54) INTERACTION GENERATION DEVICE

(71) Applicant: Philippe Laik, Monte Carlo (MC)

(72) Inventor: Philippe Laik, Monte Carlo (MC)

(21) Appl. No.: 16/086,506

(22) PCT Filed: Sep. 14, 2018
(86) PCT No.: PCT/IB2018/057070

§ 371 Date: Sep. 19, 2018

(51) Int. Cl. G06Q 50/00; G06Q 10/10

(52) U.S. Cl. CPC G06Q 50/01; G06Q 10/1095

(57) ABSTRACT

Techniques for determining a communication platform for establishing a communication with a contact, an activity list comprising a list of activity for engaging the contact, and a place list for organizing meeting with the contact is described. In an example implementation of the present subject matter, a contact from an address book is determined for establishing communication. Thereafter, selection parameters are determined for the contact. In an example, the selection parameters may be psychological factors, sociological factors, environmental factors, etc. Based on the selection parameters, the user is provided with a list of communication platforms that allows the user to establish communication with the contact. Similarly, based on the selection parameters, the activity list and the place list are also generated and provided to the user.

### BACKGROUND

Computing devices, such as a mobile device, a pager, may have a list of contacts stored in their memory storage. The list of contacts may contain contact information, such as the mobile number and emails of other users. To contact another user, the user of the computing device accesses the list of contacts and establish a contact with the other user via their contact information. The contact may be established by using variety of applications, such as a VoIP application, a video conferencing application, text application, and the like.

### SUMMARY

Techniques for determining a communication platform for establishing a communication with a contact, an activity list comprising a list of activity for engaging the contact, and a place list for organizing meeting with the contact is described. In an example implementation of the present subject matter, a contact from an address book is determined for establishing communication. Thereafter, selection parameters are determined for the contact. In an example, the selection parameters may be psychological factors, sociological factors, environmental factors, etc. Based on the selection parameters, the user is provided with a list of communication platforms that allows the user to establish communication with the contact. Similarly, based on the selection parameters, the activity list and the place list are also generated and provided to the user.

### BRIEF DESCRIPTION OF FIGURES

The following detailed description references the drawings, wherein:

FIG. 1 illustrates a network environment implementing an interaction generation device, in accordance with an example implementation of the present subject matter;

FIG. 2 illustrates an interaction generation device, in accordance with an example implementation of the present subject matter;

FIG. 3 illustrates an architecture of a system for retrieving data from databases, according to an example of the present subject matter;

FIG. 4 illustrates a graph representation of data, according to an example of the present subject matter;

FIG. 5 illustrates a method for generating list of communication platform, according to an example of the present subject matter;

FIG. 6 illustrates a method for generating list of communication platform in accordance with another example of the present subject matter.

### DETAILED DESCRIPTION

The description of the present subject matter incorporates in its entirety the specification and drawings of the US granted patent U.S. Pat. No. 6,980,870, by reference. The U.S. Pat. No. 6,980,870 discloses techniques for managing, optimizing, and scheduling personal relationship with a contact

Computing devices like mobile phones, laptops, personal computers, etc., have address books to facilitate users to store contacts details of people, such as colleagues, friends, relatives, family, doctors, service centers, restaurants, etc. A user of the computing device may use an application to communicate to a stored contact. For example, a user may use a video messenger for video conferencing with a contact. In another example, the user may use a VoIP application to communicate with another user.

For a user to communicate with a contact via an application, it is required that the contact, with which the user needs to contact, should have the application installed on his computing device and he should be comfortable in using the application for communication. It should be understood that ‘communication with a contact’ means communication with a user associated with the contact. The user may be unaware of the circumstances and situation of the contact and may try to establish a connection with the contact using an application which is not desirable for the contact. For example, it is possible that a contact likes to communicate only via text messages at office timing while the user may try to establish a connection using video conferencing. Thus, the user is not aware of the communication platform (application) a user should use to establish a communication with a contact. Further, sometimes, the user is also not aware of an activity in which the contact would be interested in. Furthermore, the user may also not be aware of which place he should propose the contact for a meeting.

According to an aspect of the present subject matter, techniques for determining a communication platform for establishing a communication with a contact, an activity list comprising a list of activity for engaging the contact, and a place list for organizing meeting with the contact is described. In an example implementation of the present subject matter, a contact from an address book is determined for establishing communication. Thereafter, selection parameters are determined for the contact. In an example, the selection parameters may be psychological factors, sociological factors, environmental factors, etc. Based on the selection parameters, the user is provided with a list of communication platforms that allows the user to establish communication with the contact. Similarly, based on the selection parameters, the activity list and the place list are also generated and provided to the user.

Thus, according to the present subject matter, a list of communication platform is generated, an activity list, and a place list is generated. As the communication platform is based on the choices of contact, an effective communication between the user and the contact is established. According to the present subject all the calculations, processing, data analysis happens at the database by backend servers. A plurality of micro software services allows parallel execution and processing of the data. The data is processed using graphical processor unit (GPU) processors at these databases which are significantly faster than the central processing units of the user's mobile device. Also, as the processing is done at backend servers, the battery power of the user's device is saved. The data is processed using graphical processor unit (GPU) processors at these databases which are significantly faster than the central processing units of the user's mobile device. In general, the mobile phone and tablet are equipped with 99% ARM processors. The back end servers are equipped with x86 processors (Intel or AMD) and GPU (Nvidia or advanced micro devices (AMD)). According to the set of benchmarks, the ARM architecture is about 8 times less efficient than the x86 architecture when it comes to complex calculation. Thus, the techniques described herein improve the operation of the processing system of the user device while providing enhanced capabilities.

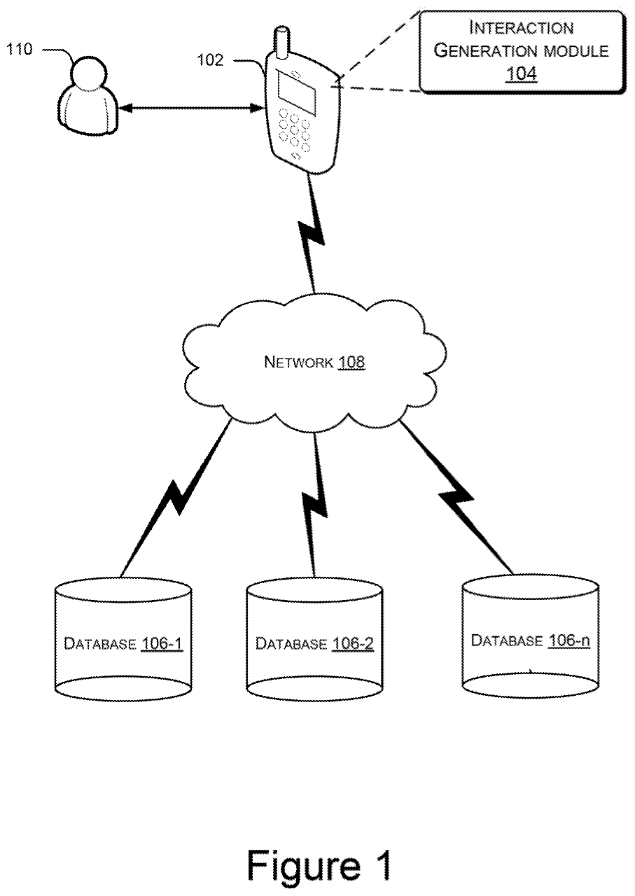

The above techniques are further described with reference to FIG. 1 to FIG. 6. It should be noted that the description and the Figures merely illustrate the principles of the present subject matter along with examples described herein and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 shows an interaction generation device 102 implementing an interaction generation module 104, to generate a list of communication platforms, according to an example implementation of the present subject matter. The interaction generation device 102 may be coupled with a plurality of databases, such as database 106-1, 106-2, . . . , 106-n, via a network 108.

The network 108 may be a single network or a combination of multiple networks and may use a variety of different communication protocols. The network 108 may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), and Public Switched Telephone Network (PSTN). Depending on the technology, the communication network 108 includes various network entities, such as gateways, routers; however, such details have been omitted for the sake of brevity of the present description.

The interaction generation device 102 may be implemented as any of a variety of conventional computing devices, including, a mobile phone, a tablet, a pager, and a laptop. Further, the databases 106-1, 106-2, . . . , 106-n may be a hierarchical database, a network database, an object-oriented database, a relational database etc.

According to an example implementation of the present subject matter, an address book comprising a plurality of contacts of a user 110, is stored in the interaction generation device 102. In an example, the address book may be stored in a database, such as the database 106-1. The interaction generation device 102 may access the database 106-1 to retrieve a contact from the address book.

In an example, the interaction generation device 102 may determine a contact for establishing connection in response to a user's input. In other words, a user may indicate, via a text-based input or a voice input, a contact to which the user needs to establish the connection. For example, the user 110 may indicate that the user 110 wishes to establish a connection with a contact, say ‘C’. In response to the user's input, the interaction generation device 102 may retrieve the contact stored in the interaction generation device 102 or in a database. The interaction generation device 102 may, thereafter, determine selection parameters for generating a list of communication platforms for the contact.

In an example, the selection parameters may be based on psychological factors, sociological factors, and environmental factors corresponding to the contact.

In an example, the interaction generation device 102 may access the databases 106-1, 106-2, . . . , 106-n to determine the selection parameters for each of the contacts saved in the address book. For example, for determining a selection parameter, such as based on sociological parameter of contacts, the interaction generation device 102 may access, via the network 108, a database, say database 106-2, to retrieve the information related to the social activities of the contact.

The databases 106-1, 160-2, 106-3 may correspond to the databases of Facebook, LinkedIn, twitter etc. The interaction generation device 102 may access the databases of the social networking website to determine selection parameters for the contacts.

Based on the selection parameters, the interaction generation module 104 may generate, based on the selection parameters, a list of communication platforms which can be used for establishing a connection with a contact. The communication platforms list may comprise a list of application which can be used to communicate with the contact. The list of communication platforms may be arranged in a hierarchical order such that the communication platform appearing on the top may indicate the most convenient mode of communication with the contact. For example, if the interaction generation device 102 determines, based on the selection parameters, that a contact is preferably uses text messages for communication, while generating a list of communication platforms for the contact, the list of communication platforms would comprise a text messaging application at the top of list.

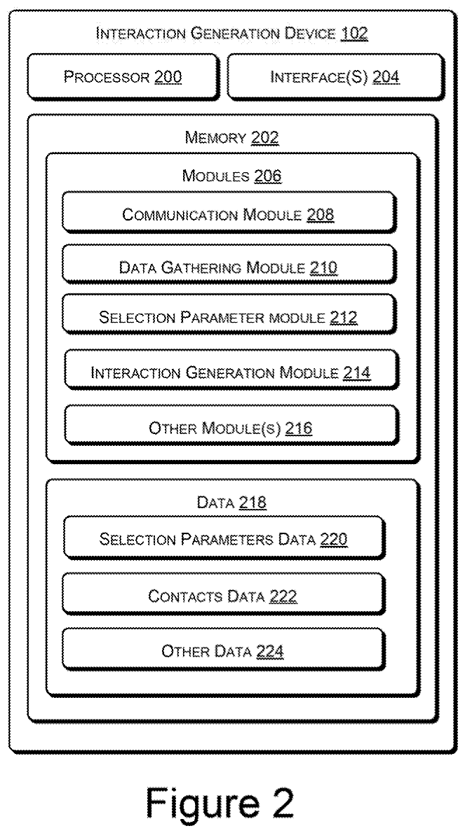

FIG. 2 illustrates the interaction generation device 102, in accordance with an example implementation of the present subject matter. The interaction generation device 102, among other things, includes processor(s) 200 and memory 202 and interface(s) 204 coupled to the processor(s) 200. The processor(s) 200 may be implemented as microprocessors, microcomputers, microcontrollers, digital signal processors, central processing units, state machines, logic circuitries, and/or any devices that manipulate signals based on operational instructions. Among other capabilities, the processor(s) 200 is configured to fetch and execute computer-readable instructions stored in the memory 202 of the interaction generation device 102. The memory 202 may include any computer-readable medium including, for example, volatile memory (e.g., RAM), and/or non-volatile memory (e.g., EPROM, flash memory, etc.).

The functions of the various elements shown in the Figures, including any functional blocks labelled as “processor(s)”, may be provided through the use of dedicated hardware as well as hardware capable of executing software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), non-volatile storage. Other hardware, conventional and/or custom, may also be included. The processor(s) 200 is responsible managing the operations of the interaction generation device 102.

The interface(s) 204 may include a variety of software and hardware interfaces, for example, interface for connected peripheral device(s) such as an external memory. Further, the interface(s) 204 may enable the interaction generation device 102 to communicate with other devices while establishing a connection with a contact. The interface(s) 204 may facilitate multiple communications within a wide variety of protocols and networks, such as the network 108, including wired networks, e.g., LAN, cable, etc., and wireless networks, e.g., WLAN, cellular, satellite, etc. The interface 204 may be used to provide inputs to interaction generation device 102. In an example, the inputs may be provided by a user.

Modules 206 and data 218 may reside in the memory 202. The modules 206 include routines, programs, objects, components, data structures, and the like, which perform particular tasks or implement particular abstract data types. In an example, the modules 206 include a communication module 208, a data gathering module 210, a selection parameter module 212, and an interaction generation module 214 (similar to the interaction generation module 104). The modules 206 may also comprise other modules 216 that supplement functions of the interaction generation device 102.

The data 218 serves, amongst other things, as a repository for storing data that may be fetched, processed, received, or generated by the modules 206. The data 218 comprises other data 224 corresponding to the other modules 216. In the illustrated example implementation, the data 218 of the interaction generation device 102 also include selection parameters data 220 and contacts data 222.

In an example, a user of the interaction generation device 102 may save the address book comprising the contacts in the contacts data 222. Further, in an example, the user may also store the address book on a database. The user may, in an example, add contacts from social networking sites, such as Facebook, LinkedIn, twitter. In such cases, the communication module 208 may communicate with a database, such as database 106-1 to transmit an address book stored on the interaction generation device 102 to the database, such as the database 106-1.

While saving a contact in the address book of the interaction generation device 102, the user may specify attributes for a contact. For example, the user may specify, during saving of the contact, say ‘A’, that the contact ‘A’ is family member of the user. The attributes may be specified by selecting an appropriate attribute during saving of the contact. For example, during saving of the contact ‘A’ the user may provide the keyword ‘family’ in the relation field of the contact ‘A’. Thus, accordingly various attributes may be defined by the users for the plurality of contacts in the address book.

Further, in an example, the attributes for the plurality of the contacts may be determined by the interaction generation device 102 and may be updated against each of the plurality of the contacts. For example, a data gathering module 210 of the interaction generation device 102 may determine an psychological attribute, sociological attribute, environmental attributes associated with a contact. In an example, the data gathering module 210 may determine an attribute for a contact based on the social media activity of the user. Thus, a plurality of attributes may be stored against each of the contact wherein the attributes may be defined by the user and determined by the interaction generation device 102. In an example, the data gathering module 210 may also monitor a history of interaction between the user and a contact. For example, the data gathering module 210 may analyze the duration of call with the contacts to determine the relation of the contact with the user.

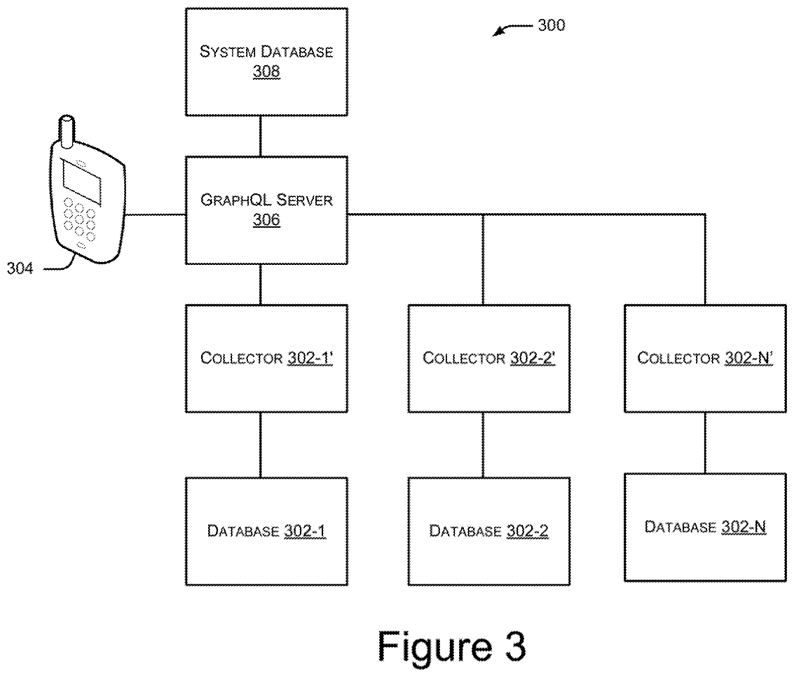

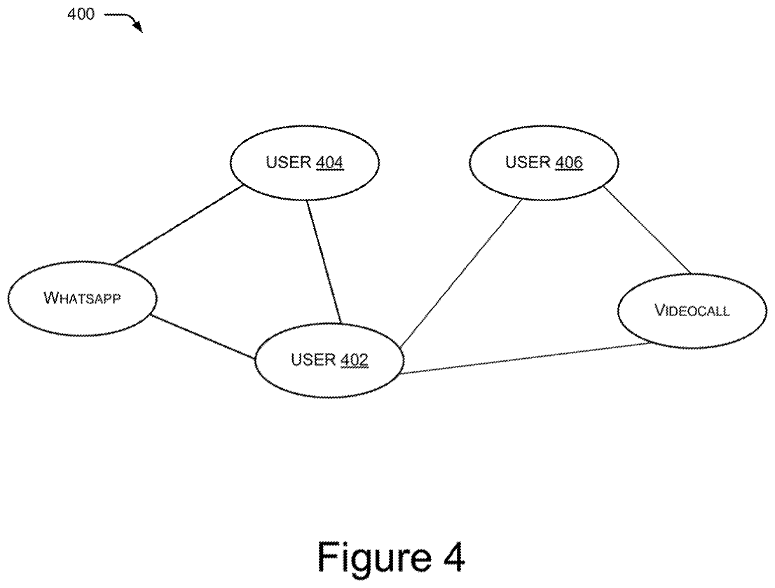

In an example, various attributes, relationships of the contacts may be represented as graphs, using tools, such as GraphQL. Using GraphQL query language is very convenient to search the interrelation between the user and the contacts. For example, the database corresponding to the Facebook, twitter, LinkedIn, google places may be accessed through a GraphQL server. In an example, a collector may be coupled with the databases of the Facebook, twitter, LinkedIn, google places and the all the collectors may in turn be coupled with the GrpahQL server. The collector may fetch the data from the databases of the social networking sites and may provide the data to the GraphQL server from which the data may be retrieved. This is explained in detail with reference to FIGS. 3 and 4.

In another example, the data gathering module 210 may also query a mongoDB, Neo4j database to fetch details about the psychology, sociology parameters of the uses. These database store data in Hadoop environment. Thus, these big data solutions allow database to maintain a liner relationship with respect to the increase of load. The data gathering module 210 may also search in various open sources databases. Opensource solution allows to search for classify and perform a complex set of statistics on digital data.

In operation, when a user requests for establishing a connection between a contact, the selection parameter module 212 may determine selection parameters for the contact. Based on the selection parameters, a value for each of the communicating mode for a contact is defined. For example, for a contact ‘X’, different mode of communications, such as voice communication, video communication, message communication, voice-mail communication may be given a value, based on the selection parameters. The interaction generation module 214 may thereafter, create a list of communication platforms based on the values defined for each of the communication mode.

For example, for a selection parameter, such as ‘mode of communication’ the contact would be allotted a value for each of the mode of communication. For example, if the contact A is ‘father’ of user, the mode of communication, such as Voice call or video call may be given high values than the mode of communication text message. For example, for contact ‘A’, the defined values may be as provided in the table below:

TABLE 1

| Mode of communication | Allotted value for ‘A’ |
|---|---|
| Voice call | 1 |
| Video call | 1 |
| Text message | 0.5 |
| Facebook Messenger | 0.25 |
| Email | 0.10 |

Thus, when the user tries to establish communication with the contact A, the interaction generation module 214 generates a list of communication platforms which comprises a list of platforms which the can be used to establish contact with the contact A. In this example, where the contact A is ‘father’ of the user, the list of communication platforms would comprise a list of application which can be used to establish a voice and video communication with the contact A. Further, the list may also comprise other applications, such as applications for text message, such as Facebook messenger, email arranged in lower priority than that the applications for voice and video communication.

In another example, if a user is trying to establish communication with a contact ‘B’ and it is determined by the data gathering module 210 that location of the contact B or the location of user is ‘office’, the interaction generation module 214 may generate a list of communication platforms such that a communication platform having a messaging capability is listed on the top. It is because, it is common that people tend to interact via messaging application during work timings.

In an example, if the user is not satisfied with the generated list of communication platforms, the user may regenerate the list of communication platforms. In such cases, a new set of selection parameters may be determined for the contact and thereafter a new list of communication platforms may be generated. In another, example, the user may increase or decrease the priority of the mode of communication with a contact and may regenerate the list of communication based on the new priority.

Further, in an example, the interaction generation module 214 may also generate recommendation for an activity for the contact. For example, a contact ‘X’ may be indicated to be interested in shopping, a contact ‘Y’ may be indicated to be interested in movies and so on. The user may select an appropriate activity for a contact and may propose the contact for participating in the activity. In another example, the interaction generation module 214 may also suggest an activity for the user and the contact, based on the psychological profile of the user.

Further, in an example, the psychological profile parameters for the user and the individuals may be determined by the interaction generation device 102 and may be updated against the user and the individuals. For example, system may determine a psychological parameter, sociological parameter, environmental parameter associated with the user and the individuals. In an example, the system may determine a parameter for the user and the individuals based on the social media activity of the user and the individuals. Thus, a plurality of profile parameters may be stored against user and the individuals. In an example, the profile parameters may be based on a personal character, an emotional state, objective of life, business objective, behaviors, attitude, professional objective, love objective of the user and the individuals. To determine the profile parameters, the system may access social media profiles, status, social media accounts, posts of the user and the individuals in order to determine the profile parameters of the users. In an example, the social media posts, status, events, may depict a mood, personality, and social connections of the user and the individuals. Further, the system may also analyze the user's database, such as image gallery of the user's device, to determine profile parameters, such as body type, personality type etc. The profile parameters may be stored in the data 218.

In an example, the system may also monitor a history of interactions between the user and the individuals to determine interaction parameters of the user and the individuals. For example, the system may analyze the applications the user and the individuals use in their communication, the frequency and duration of calls. In one embodiment, the system may analyze communications and interactions and normalize the data in a particular format for semantic analysis. The system can then use a language analysis algorithm to extract a sense of the exchanges and generate profile parameters. In an example, the system allots a value to each of the profile parameters. For example, a set of profile parameters are shown below in table 1;

| Profile Parameters | Maximum Value | Minimum Value |
|---|---|---|
| Helpfulness | 1 | 10 |
| Objective of life | 1 | 5 |
| Extroversion/sociability | 1 | 7 |
| Independence | 1 | 6 |
| Frequency of contact | 1 | 5 |

In an example, the system may assign values to each of the profile parameters. For example, based on the social media activity and other psychological factors the system may analyze a personal character of the user and may determine that the user is helpful and may assign a value to the profile parameter helpfulness. In an example, the helpfulness may have a minimum value of 1 and a maximum value of 10. In an example, the helpfulness of the user may be determined by analyzing his day to day activities, such as receiving of donation receipts on the user's mail may employ that the user is helpful. Further, values may be assigned to each of the profile parameters.

In one embodiment, the system may note that data is lacking in certain of the parameters and metrics. The system may inject the data into a neuronal network to infer the missing information. This makes it possible to determine additional centers of interest that are not expressly indicated by the user or by the user interaction. In one embodiment, a profile such as below may be generated and updated in real time based on new interactions to various social media platforms.

| | | | Minimum | Maximum |
|---|---|---|---|---|
| Designation | ID | Category | Value | Value |
| Importance of relation | Importance | Settings | 1 | 10 |
| Frequency of relation | Frequency | Settings | 0 | 100 |
| Curiosity: (Curious/Open or Routine/ | psyC | Psy OCEAN | 1 | 7 |
| Traditional) | | | | |
| Extroversion/Sociability: (Energetic/ | psyS | Psy OCEAN | 1 | 7 |
| dynamic or reserved/quiet) | | | | |
| Emotivity: (calm/relaxed or emotional/ | psyE | Psy OCEAN | 1 | 7 |
| stressed) | | | | |
| Preventance/Accommodation or Service: | psyA | Psy OCEAN | 1 | 7 |
| (Conciliatory/Helpful or Stubborn) | | | | |
| Organization/Reliability: (Organized/ | psyO | Psy OCEAN | 1 | 7 |
| Methodical or Impulsive/Distracted) | | | | |
| Tradition | valT | human | 1 | 9 |
| | | value | | |
| Universalism | valU | human | 1 | 9 |
| | | value | | |
| Independence | valI | human | 1 | 9 |
| | | value | | |
| Stimulation | valS | human | 1 | 9 |
| | | value | | |
| Power | valP | human | 1 | 9 |
| | | value | | |

Further, in an example, the interaction generation module 214 may provide suggestion for a place of conducting the activity. For example, if the user and a contact or a group of contact has mutually agreed on an activity, say ‘watching a movie’, the interaction generation module 214 may generate a list of nearby movie theaters. For example, the interaction generation module 214 open streetmap to determine the location of the nearby movie theaters and may, thereafter provide the location to the user. Further, in an example, the interaction generation module 214 may also generate additional tips and suggestions. For example, the interaction generation module 214 may generate a suggestion to carry an umbrella if it is determined that it is raining outside. Further, the interaction generation module 214 may also generate a review of a place where the user is heading for the activity. In an example, the interaction generation module 214 may generate a review from analyzing public reviews of that particular place.

In an example, the user may select an appropriate mode of communication platform for communicating with a contact and may thereafter communicate with the contact. For example, if it is determined that a particular contact is comfortable in communicating via text messages, the user may open a messaging application to contact with the contact. In an example, the messaging application may provide suggestion to the user for messaging the contact. For example, messaging application may suggest various template messages and the user may select a template message to be sent to the user. In another example, the messaging application may provide template message in the language in which the contact is comfortable in communication. The translation of the template messages may also be reflected for the reference to the user. In an example, the template message may be provided, based on the last interaction with the contact, sex of contact, history of the communication with the contact. In an example, if the user is conversing with the contact regarding a published article, a link of the published article may be provided to the user, which the user can share with the contact. In an example, the user may access previous conversations that happened between the contact and the user. In an example, the user may access a chat history, recorded calls etc.

FIG. 3 describes an architecture 300 for a system for retrieving data, such as selection parameters from databases, such as databases of social media accounts of the user. As explained earlier, the interaction generation device 102 may access the databases of the social networking website to determine selection parameters. FIG. 3 shows a database 302-1, a database 302-2, . . . , a database 302-N coupled to an interaction generation device 304 via a GraphQL server 306. In an example, a collector 302-1′, a collector 302-2′, and a collector 302-N′ may be coupled with each of the database 302-1, the database 302-2, and the database 302-N, respectively. The collector 302-1′, the collector 302-2′, and the collector 302-N′ may be also coupled with the GraphQL server 306. The interaction generation device 304 may communicate over HyperText Transfer Protocol (HTTPS) with the GraphQL server 306 to retrieve the details from the database 302-1, the database 302-2, and the database 302-N. In an example, the database 302-1, the database 302-2, and the database 302-N may correspond to the databases of social media accounts of user, such as Facebook, LinkedIn, google places, twitter etc. In an example, the interaction generation device 304 may require a permission from a user to access his social account data. For example, a user may be provided a prompt ‘collect my data from Twitter’ and when the user allows the prompt, the user is directed to the Twitter page where the user authenticates the interaction generation device 304 to collect data from Twitter. In an example, consider that the database 302-1 corresponds to Twitter. The interaction generation device 304 sends a message to GraphQL server 306 which may in turn initiate the collector 302-1′ of the database 302-1 to collect data from the database 302-1. In an example, the GraphQL server 306 may send a message indication the data that is required. In an example, the message may comprise keywords, like ‘communication platform used for last ten video calls’. The collector 302-1′ will collect the data and will provide the data to the GraphQL server 306 and the GraphQL server 306 may store the data in a system database 308. Similarly, data from all the other databases are collected and stored in the system database 308. The GraphQL server 306 may provide the required data, such as selection parameters to the interaction generation device 304, when required. In an example, the database 302-1, 302-3, . . . , 302-N may be implemented on mongoDB and the GraphQL server may utilize mongoDb protocol for communication with the collector 302-1′, 302-2′, . . . , 302-N′. In an example, apache spark may be employed to manage a plurality of computing systems and plurality of databases.

In an example, the data in the system database 308 may be stored in an encrypted form. The encryption of the data may be done using NTRU algorithm. Due to strong protection mechanism, such as NTRU algorithm, it is very difficult for a malicious user to access sensitive personal data. Thus, changes of privacy breach are very minimal in the current system as compared to the conventional system.

Further, in an example, the data may be stored in the system database 308 in a graph form 400 as shown in FIG. 4. In an example, in the graph form 400 a data of a user 402 is linked with each other for better analysis and utilization of the data. For example, if the user 402 it is determined that the user communicates frequency through whatsapp and further it is determined that another user 404, which is a contact in the address book of the user, also uses whatsapp frequently for communication, a connection is created for the user 402 as shown in the figure. In an another example, it may be indicated on the graph form 400 that the user 402 communicates frequently via video call with another user 406, who is a family member of the user 406. Retrieving the data from the graph 400 is more easier and more faster compared to conventional means. In a graph form, such as the graph form 400, a single query may by be run to derive results. Thus, such graph forms are faster than standardized query language (SQL) and other conventional methods.

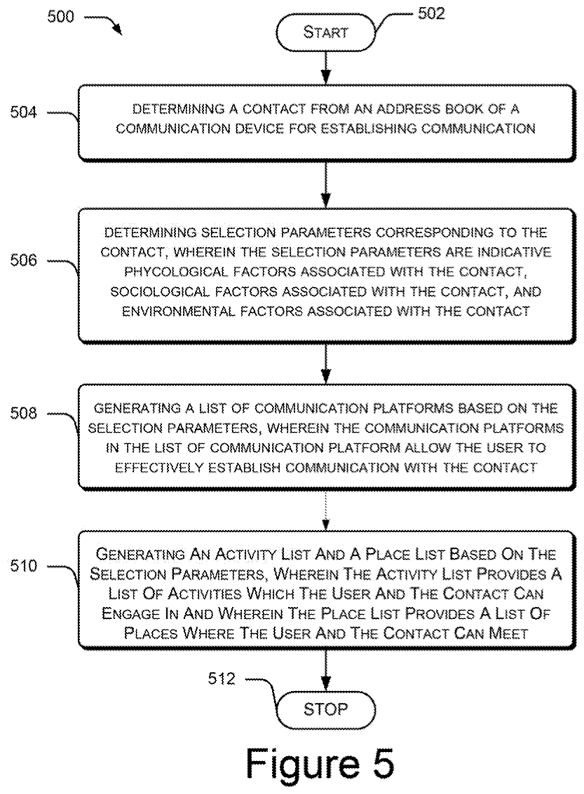

FIG. 5 illustrates a method 500 for generating list of communication platforms contacts, in accordance with an example of the present subject matter. Although the method 500 may be implemented in a variety of interaction generation devices, for the ease of explanation, the present description of the example method 500 to generate the second list of selective contacts is provided in reference to the above-described interaction generation device 102.

The order in which the method 500 is described is not intended to be construed as a limitation, and any number of the described method blocks may be combined in any order to implement the method 500, or an alternative method.

The method starts at block 502 and proceeds to block 504. At block 504, a contact from an address book of a communication device for establishing communication is determined. The contact may be selected by a user or may be determined by the interaction generation device. For example, based on the user's activity, location, etc., the interaction generation device can determine a contact with which the communication is needed to be established.

At block 506, selection parameters for the contact are determined. As described previously, selection parameters are indicative psychological factors associated with the contact, sociological factors associated with the contact, and environmental factors associated with the contact.

At block 508 a list of communication platforms, based on the selection parameters, is generated. The list of communication platform allow user to effectively establish communication with the contact. The communication platforms can have dynamically changing rankings, based on both temporal information (e.g. time of day, weekday or weekend, etc.) and location-based information (is user at the office, home, driving or commuting, shopping, etc.)

At block 510 an activity list and a place list is generated based on the selection parameters. The activity list provides a list of activities which the user and the contact can engage in and the place list provides a list of places where the user and the contact can meet. Thereafter, the method stops at block 512. The list of communication platforms provides a list of applications which can be used by a user to establish communication with the contact.

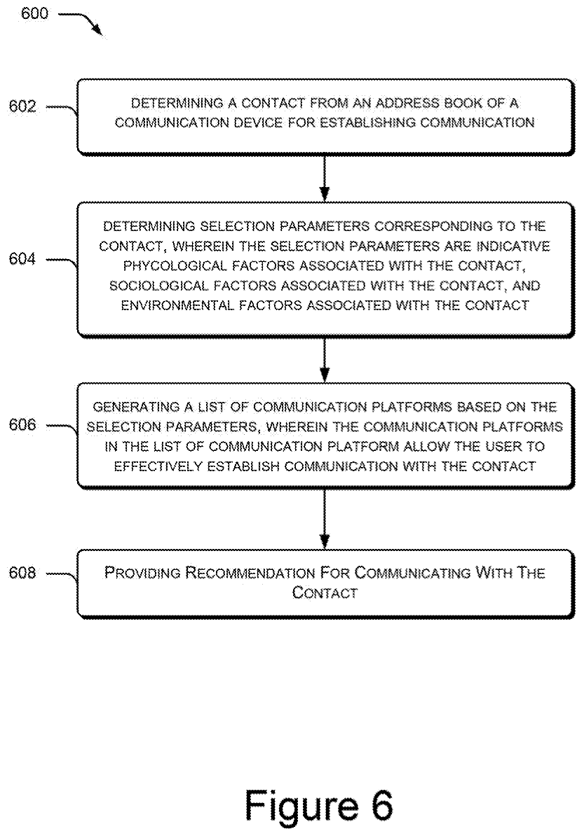

FIG. 6 illustrates a method 600 for generating list of communication platforms contacts, in accordance with an example of the present subject matter. Although the method 600 may be implemented in a variety of interaction generation devices, for the ease of explanation, the present description of the example method 600 to generate the second list of selective contacts is provided in reference to the above-described the interaction generation device 102.

The order in which the method 600 is described is not intended to be construed as a limitation, and any number of the described method blocks may be combined in any order to implement the method 600, or an alternative method.

According to the method 600, block 602-606 is similar to the block 504-508 of the method 500 and at block 606, a list of communication platform, based on the selection parameters, is generated. At block 608, recommendation for the communication may be provided. For example, recommendation may be provided for engaging in an activity with the contact. In another example, topic of discussion may be provided to the user. In yet another example, a place of meeting, with the contact, may be recommended. The activity for engagement, place of meeting, topic of discussion may be provided based on the choices and preferences for the user.

Thus, the methods and devices of the present subject matter provide techniques to generate list of communication platform. Although examples of generating the list of communication platform as described, have been described in a language, specific to structural features and/or methods, it is to be understood that the appended claims are not necessarily limited to the specific features or methods described. Rather, the specific features and methods are disclosed as example for generating the list of communication platforms.

1. A method comprising:
determining a contact out of plurality of contacts from an address book of a communication device for establishing communication;
determining selection parameters corresponding to the contact, wherein the selection parameters are indicative of psychological factors associated with the contact, sociological factors associated with the contact, and environmental factors associated with the contact;
generating a list of communication platforms based on the selection parameters, wherein the communication platforms in the list of communication platforms allow a user to effectively establish communication with the contact;
generating an activity list and a place list based on the selection parameters, wherein the activity list provides a list of activities which the user and the contact can engage in and wherein the place list provides a list of places where the user and the contact can meet.

2. The method as claimed in claim 1, wherein the selection parameters are determined by a system and is based on at least one of location of user, time of communication, an event associated with the user, psychological factors, sociological factors, environmental factors.

3. The method as claimed in claim 1, wherein for the plurality of the contacts, a plurality of attributes is defined by the user and a system, wherein the attributes comprise at least one of relation of contact with the user, interest of the contact, hobby of the contact, psychological factors, sociological factors, environmental factors of the contact.

4. The method as claimed in claim 3, wherein the attributes defined by the system are determined by accessing open source databases.

5. The method as claimed in claim 1, wherein the method further comprises allotting a value for each mode of communication with the contact wherein the values are based on at least one of user preferences, relation of user with the contact, system defined preferences, location of user, location of contact, meeting schedule of the user, meeting schedule of the contact.

6. The method as claimed in claim 5, wherein the list of communication platforms is generated based on the allotted value.

7. The method as claimed in claim 6, wherein a communication with the contact is established via a communication platform selected from the list of communication platforms.

8. A interaction generation device comprising:
a communication module to determine a contact out of a plurality of contacts from an address book of a communication device for establishing communication;
a selection parameter module to determine selection parameters corresponding to the contact, wherein the selection parameters are indicative of psychological factors associated with the contact, sociological factors associated with the contact, and environmental factors associated with the contact;
an interaction generation module to:
generate a list of communication platforms based on the selection parameters, wherein the communication platforms in the list of communication platform allow a user to effectively establish communication with the contact;
generating an activity list and a place list based on the selection parameters, wherein the activity list provides a list of activities which the user and the contact can engage in and wherein the place list provides a list of places where the user and the contact can meet.

9. The interaction generation device as claimed in claim 8, wherein the selection parameters are determined by the interaction generation device and is based on at least one of location of user, time of communication, an event associated with the user, psychological factors, sociological factors, environmental factors.

10. The interaction generation device as claimed in claim 8, for the plurality of the contacts, a plurality of attributes is defined by the user and the interaction generation device, wherein the attributes comprise at least one of relation of contact with the user, interest of the contact, hobby of the contact, psychological factors, sociological factors, environmental factors of the contact.

11. The interaction generation device as claimed in claim 10 further comprising a data gathering module to access databases for determining the attributes for contacts.

12. The interaction generation device as claimed in claim 8, wherein the selection parameter module allots a value for each mode of communication with the contact wherein the values are based on at least one of user preferences, relation of user with the contact, system defined preferences, location of user, location of contact, meeting schedule of the user, meeting schedule of the contact.

13. The interaction generation device as claimed in claim 12, wherein the list of communication platforms is generated based on the allotted value.

14. The interaction generation device as claimed in claim 8, wherein the communication module is used to establish a communication with the contact wherein the communication is established via one of the communication platforms from the list of communication platforms.

15. The interaction generation device as claimed in claim 8, wherein the user proposes an activity for the contact based on the activity list and proposes a place for meeting based on the place list.
